(19) United States
(12) Patent Application Publication
(10) Pub. No.: US 2025/0303495 A1
(43) Pub. Date: Oct. 2, 2025

(54) Projection laser machining method using laser machining mask assembly

(71) Applicant: Tripod Technology Corporation, Taoyuan City (TW)

(72) Inventors: Chang Ching TSAI, Taoyuan City (TW); Sen-Yong CHEN, Taoyuan City (TW); Sheng-Ru LEE, Taoyuan City (TW); Paichun CHANG, Taoyuan City (TW)

(21) Appl. No.: 18/791,692

(22) Filed: Aug. 1, 2024

(30) Foreign Application Priority Data
Mar. 27, 2024 (TW) 113111485

(51) Int. Cl. B23K 26/066; B23K 26/06; B23K 26/073

(52) U.S. Cl. CPC B23K 26/066; B23K 26/0648; B23K 26/073

(57) ABSTRACT

A projection laser machining method using a laser-machining-mask-assembly comprises following steps of: providing a machining laser apparatus, the laser-machining-mask-assembly and a projection lens such that the laser-machining-mask-assembly, the projection lens and a workpiece are sequentially arranged on a propagation path of a laser beam generated by the machining laser apparatus along a propagation direction of the laser beam, the laser-machining-mask-assembly comprises an initial mask and a correction mask, the initial mask is amplitude-mask-type, the correction mask is amplitude-mask-type or phase-mask-type, the correction mask is arranged between the initial mask and the projection lens or the initial mask is arranged between the correction mask and the projection lens; and performing a laser machining process on the workpiece; wherein a beam size of the laser beam projected on a projection focal plane after the laser beam propagating through the laser-machining-mask-assembly and the projection lens can be effectively controlled.

### FIELD OF THE INVENTION

The present invention is related to a projection laser machining method using a laser machining mask assembly, especially the projection laser machining method using the laser machining mask assembly with a correction mask, to effectively control a beam size of a laser beam projected on a projection focal plane after the laser beam propagating through the laser machining mask assembly and a projection lens.

### BACKGROUND OF THE INVENTION

Please refer to FIG. 4A, which is a cross-sectional schematic view of an embodiment of a projection laser machining system using a laser machining mask of conventional technology. Please also refer to FIG. 4B, which is a schematic top view of the laser machining mask of the embodiment of FIG. 4A of conventional technology. A projection laser machining system 9 using a laser machining mask 90 of convention technology comprises a machining laser apparatus 91, the laser machining mask 90 and a projection lens 92. The laser machining mask 90, the projection lens 92 and a workpiece 93 are sequentially arranged on a propagation path of a laser beam 94 generated by the machining laser apparatus 91 along a propagation direction of the laser beam 94. The laser machining mask 90 is amplitude mask type. The laser machining mask 90 comprises a mask substrate 97 and a masking layer 98. The masking layer 98 is formed on a surface 99 of the mask substrate 97. The laser machining mask 90 includes a masked region 96 where the masking layer 98 is formed and an unmasked region 95 where the masking layer 98 is not formed (that is, the region outside the masked region 96). The unmasked region 95 has a shape of a circle. A wavelength of the laser beam 94 generated by the machining laser apparatus 91 is 248 nm. A magnification of the projection lens 92 is 0.4 times. A diameter of the circle of the unmasked region 95 is equal to 7.5 μm. A mask-projection spacing p is between the masked region 96 of the laser machining mask 90 and the projection lens 92. The mask-projection spacing p is equal to 60 mm. Please also refer to FIG. 4C, which is a schematic diagram of an irradiance profile of the laser beam simulating the laser beam of the embodiment of FIG. 4A of conventional technology projected on a projection focal plane after propagating through the laser machining mask and the projection lens. And please also refer to FIG. 4D, which is a cross-sectional irradiance profile schematic diagram of the laser beam of FIG. 4C of conventional technology along radial section (R-axis passes through X-axis=0 and Y-axis=0). By simulation, after the laser beam 94 propagates through the unmasked region 95 of the laser machining mask 90 and the projection lens 92, the laser beam 94 is projected on a projection focal plane (for example, projected on the workpiece 93), the irradiance profile of the laser beam 94 is as shown in FIG. 4C. A full width at half maximum (FWHM) of the cross-sectional irradiance profile of the laser beam 94 of FIG. 4D of conventional technology along radial section is equal to 2.336 μm. It can be observed from FIG. 4D that a steepness of the cross-sectional irradiance profile of the laser beam 94 along radial section is not very high. When performing laser drilling process on the workpiece 93, if the steepness of the cross-sectional irradiance profile of the laser beam 94 along radial section is not high enough, then a steepness of a hole drilled by laser drilling process will not be too high either; and it is easy to form the hole with a wider opening and a narrower bottom. Furthermore, in FIG. 4D, the diffraction pattern of the irradiance profile of the laser beam 94 after the laser beam 94 propagating through the unmasked region 95 of the laser machining mask 90 and the projection lens 92 can be observed in the region beyond the spot central of the laser beam 94 (for example, in the region where R-axis is smaller than −2 μm or greater than 2 μm). When performing laser drilling process on the workpiece 93, not only the spot central of the laser beam 94 is used for drilling a hole, but also the diffraction pattern of the laser beam 94 will irradiate on the surface of the workpiece 93 around an opening of the hole drilled by the laser beam 94. Although the irradiance of the diffraction pattern is low, the diffraction pattern may also damage the surface structure of the workpiece 93 around the opening of the hole.

Please refer to FIG. 5A, which is a cross-sectional schematic view of another embodiment of a projection laser machining system using a laser machining mask of conventional technology. Please also refer to FIG. 5B, which is a schematic top view of the laser machining mask of the embodiment of FIG. 5A of conventional technology. The main structure of the embodiment of FIGS. 5A and 5B is basically the same as the structure of embodiment of FIGS. 4A and 4B, except that the shape of the unmasked region 95 of the laser machining mask 90 is a rectangle, wherein a longer side of the rectangle is equal to 7.5 μm, a shorter side of the rectangle is equal to 6 μm. A wavelength of the laser beam 94 generated by the machining laser apparatus 91 is 248 nm. A magnification of the projection lens 92 is 0.4 times. A mask-projection spacing p is between the masked region 96 of the laser machining mask 90 and the projection lens 92. The mask-projection spacing p is equal to 60 mm. Please also refer to FIG. 5C, which is a schematic diagram of an irradiance profile of the laser beam simulating the laser beam of the embodiment of FIG. 5A of conventional technology projected on a projection focal plane after propagating through the laser machining mask and the projection lens. And please also refer to FIGS. 5D and 5E, which are cross-sectional irradiance profile schematic diagrams of the laser beam of FIG. 5C of conventional technology along X-axis section and along Y-axis section, respectively. By simulation, that after the laser beam 94 propagates through the unmasked region 95 of the laser machining mask 90 and the projection lens 92, the laser beam 94 is projected on a projection focal plane (for example, projected on the workpiece 93), the irradiance profile of the laser beam 94 is as shown in FIG. 5C. A full width at half maximum of the cross-sectional irradiance profile of the laser beam 94 of FIG. 5D of conventional technology along X-axis section is equal to 2.293 μm. A full width at half maximum of the cross-sectional irradiance profile of the laser beam 94 of FIG. 5E of conventional technology along Y-axis section is equal to 2.349 μm. It can be observed from FIG. 5D that a steepness of the cross-sectional irradiance profile of the laser beam 94 along X-axis section is not very high. When performing laser scribing process on the workpiece 93, the laser beam 94 is moving along Y-axis while performing laser scribing process to scribe a long groove along Y-axis. If the steepness of the cross-sectional irradiance profile of the laser beam 94 along X-axis section is not high enough, then the long groove (the long groove is along Y-axis) will not have a high steepness of the cross-section of the long groove along X-axis section (the cross-section is along X-axis section). Hence, it is easy to form the along Y-axis long groove with a wider opening along X-axis section and a narrower bottom along X-axis section. Furthermore, in FIG. 5D, the diffraction pattern of the irradiance profile of the laser beam 94 after the laser beam 94 propagating through the unmasked region 95 of the laser machining mask 90 and the projection lens 92 can be observed in the region beyond the spot central of the laser beam 94 along X-axis section (for example, in the region where X-axis is smaller than −2 μm or greater than 2 μm). When performing laser scribing process on the workpiece 93, the laser beam 94 is moving along Y-axis while performing laser scribing process to scribe the long groove along Y-axis. In the meantime, the diffraction pattern of the laser beam 94 will irradiate on the surface of the workpiece 93 around an opening of the cross-section (the cross-section along X-axis section) of the long groove. Although the irradiance of the diffraction pattern is low, the diffraction pattern may also damage the surface structure of the workpiece 93 around the opening of the cross-section (the cross-section along X-axis section) of the long groove.

### SUMMARY OF THE INVENTION

The main technical problems that the present invention is seeking to solve is how to provide a projection laser machining method using a laser machining mask assembly, so that a beam size of the laser beam projected on a projection focal plane after the laser beam propagating through the laser machining mask assembly and the projection lens can be effectively controlled.

In order to solve the above described problems and to achieve the expected effect, the present invention provides a projection laser machining method using a laser machining mask assembly, which comprises following steps of: providing a machining laser apparatus, the laser machining mask assembly and a projection lens such that the laser machining mask assembly, the projection lens and a workpiece are sequentially arranged on a propagation path of a laser beam generated by the machining laser apparatus along a propagation direction of the laser beam, wherein the laser machining mask assembly comprises an initial mask and a first correction mask, the initial mask is amplitude mask type, the first correction mask is amplitude mask type or phase mask type, the first correction mask is arranged between the initial mask and the projection lens or the initial mask is arranged between the first correction mask and the projection lens; and performing a laser machining process on the workpiece; wherein a beam size of the laser beam projected on a projection focal plane after the laser beam propagating through the laser machining mask assembly and the projection lens can be effectively controlled by using the first correction mask.

In implementation, the initial mask comprises an initial masked region and one or more initial unmasked region, the first correction mask comprises one or more first mapping region, wherein the one or more first mapping region of the first correction mask is where the one or more initial unmasked region of the initial mask mapping to the first correction mask along the propagation path of the laser beam, each of the one or more first mapping region and a corresponding one of the one or more initial unmasked region have an identical shape and an identical area respectively, any of the one or more first mapping region is amplitude mask type or phase mask type.

In implementation, the laser machining process is a laser drilling process, a laser scribing process, a laser polishing process, a laser patterning process or any combination thereof.

In implementation, at least one of the one or more first mapping region is amplitude mask type, the at least one of the one or more first mapping region comprises a first mapping masked region and a first mapping unmasked region.

In implementation, the at least one of the one or more first mapping region has a shape of a circle.

In implementation, the first correction mask is arranged between the initial mask and the projection lens, the at least one of the one or more first mapping region has a shape of a circle, the first mapping masked region of the at least one of the one or more first mapping region has a shape of a ring, wherein the ring is symmetrical about a center of the circle.

In implementation, an outer diameter of the ring is smaller than a diameter of the circle.

In implementation, a ratio of an inner diameter of the ring to the diameter of the circle is between 2:15 and 2:5. In implementation, a ratio of the outer diameter of the ring to the diameter of the circle is between 2:3 and 14:15.

In implementation, the diameter of the circle is greater than or equal to 10 times a wavelength of the laser beam and smaller than or equal to 91 times the wavelength of the laser beam. In implementation, a spacing is between the initial masked region and the first mapping masked region along the propagation direction of the laser beam, the spacing is greater than or equal to 403 times the wavelength of the laser beam and smaller than or equal to 24194 times the wavelength of the laser beam.

In implementation, the first correction mask further comprises one or more surrounding region, each of the one or more surrounding region surrounds a corresponding one of the one or more first mapping region.

In implementation, any one of the one or more surrounding region and a corresponding one of the one or more first mapping region are both amplitude mask type or both phase mask type.

In implementation, at least one of the one or more surrounding region and a corresponding one of the one or more first mapping region are both amplitude mask type, each of the at least one of the one or more surrounding region comprises a surrounding masked region and a surrounding unmasked region; wherein the corresponding one of the one or more first mapping region comprises a first mapping masked region and a first mapping unmasked region.

In implementation, the at least one of the one or more first mapping region has a shape of a mapping rectangle.

In implementation, the surrounding masked region of the at least one of the one or more surrounding region is connected to the first mapping masked region of the corresponding one of the one or more first mapping region.

In implementation, the first correction mask is arranged between the initial mask and the projection lens, the surrounding masked region of the at least one of the one or more surrounding region is connected to the first mapping masked region of the corresponding one of the one or more first mapping region to form a connected rectangle.

In implementation, the first correction mask is arranged between the initial mask and the projection lens, one of the one or more first mapping region and a corresponding one of the one or more surrounding region are both amplitude mask type, the one of the one or more first mapping region has a shape of a mapping rectangle, the first mapping masked region of the one of the one or more first mapping region is connected to the surrounding masked region of the corresponding one of the one or more surrounding region to form a connected rectangle, a geometric center of the mapping rectangle is coincident with a geometric center of the connected rectangle, a longer side of the mapping rectangle is parallel with a longer side of the connected rectangle.

In implementation, the longer side of the mapping rectangle is smaller than the longer side of the connected rectangle, a shorter side of the mapping rectangle is greater than a shorter side of the connected rectangle.

In implementation, a ratio of the longer side of the mapping rectangle to the longer side of the connected rectangle is between 5:12 and 15:44. In implementation, a ratio of the shorter side of the mapping rectangle to the shorter side of the connected rectangle is between 2:1 and 6:5.

In implementation, the longer side of the mapping rectangle is greater than or equal to 10 times a wavelength of the laser beam and smaller than or equal to 91 times the wavelength of the laser beam, a shorter side of the mapping rectangle is greater than or equal to 8 times the wavelength of the laser beam and smaller than or equal to 73 times the wavelength of the laser beam. In implementation, a spacing is between the initial masked region and the first mapping masked region along the propagation direction of the laser beam, the spacing is greater than or equal to 403 times the wavelength of the laser beam and smaller than or equal to 24194 times the wavelength of the laser beam.

In implementation, the laser machining mask assembly further comprises a second correction mask, the initial mask is arranged between the first correction mask and the second correction mask or the first correction mask is arranged between the initial mask and the second correction mask, the second correction mask is amplitude mask type or phase mask type, wherein the beam size of the laser beam projected on the projection focal plane after the laser beam propagating through the laser machining mask assembly and the projection lens can be effectively controlled by using the first correction mask and the second correction mask.

In implementation, the second correction mask comprises one or more second mapping region, wherein the one or more second mapping region of the second correction mask is where the one or more initial unmasked region of the initial mask mapping to the second correction mask along the propagation path of the laser beam, each of the one or more second mapping region and a corresponding one of the one or more initial unmasked region have an identical shape and an identical area respectively, any of the one or more second mapping region is amplitude mask type or phase mask type.

In implementation, at least one of the one or more second mapping region is amplitude mask type, the at least one of the one or more second mapping region comprises a second mapping masked region and a second mapping unmasked region.

In implementation, the initial mask comprises an initial mask substrate and an initial masking layer, wherein the initial masking layer is formed on a first surface of the initial mask substrate within the initial masked region of the initial mask.

In implementation, the initial mask substrate has a second surface, the second surface is relative to the first surface of the initial mask substrate along the propagation path of the laser beam, the first correction mask comprises a first correction masking layer, the first correction masking layer is formed on the second surface of the initial mask substrate, the first correction masking layer is the first mapping masked region of the at least one of the one or more first mapping region of the first correction mask.

In implementation, the initial mask substrate of the initial mask comprises one or more penetrating through region, the one or more penetrating through region penetrates through the initial mask substrate along the propagation direction of the laser beam, the one or more penetrating through region is the one or more initial unmasked region of the initial mask.

In implementation, the initial mask comprises an initial mask base, the initial mask base comprises one or more penetrating through region and a non-penetrating region, the one or more penetrating through region penetrates through the initial mask base along the propagation direction of the laser beam, the one or more penetrating through region is the one or more initial unmasked region of the initial mask, the non-penetrating region is the initial masked region of the initial mask.

In implementation, the first correction mask comprises a first correction mask substrate and a first correction masking layer, the first correction masking layer is formed on a surface of the first correction mask substrate within the first mapping masked region of the at least one of the one or more first mapping region of the first correction mask.

For further understanding the characteristics and effects of the present invention, some preferred embodiments referred to drawings are in detail described as follows.

### BRIEF DESCRIPTION OF DRAWINGS

FIG. 1A is a cross-sectional schematic view of an embodiment of a projection laser machining system using a laser machining mask assembly of the present invention.

FIG. 1B is a schematic top view of the initial mask of the laser machining mask assembly of the embodiment of FIG. 1A.

FIG. 1C is a schematic top view of the first correction mask of the laser machining mask assembly of the embodiment of FIG. 1A.

FIG. 1D is a schematic diagram of an irradiance profile of the laser beam simulating the laser beam of the embodiment of FIG. 1A projected on a projection focal plane after propagating through the laser machining mask assembly and the projection lens.

FIG. 1E is a cross-sectional irradiance profile schematic diagram of the laser beam of FIG. 1D along radial section.

FIG. 1F is a comparison of the cross-sectional irradiance profile schematic diagram of the laser beam of FIG. 1E of the present invention along radial section and the cross-sectional irradiance profile schematic diagram of the laser beam of FIG. 4D of conventional technology along radial section.

FIG. 1G is a comparison of the normalized cross-sectional irradiance profile schematic diagram of the laser beam of FIG. 1E of the present invention along radial section and the normalized cross-sectional irradiance profile schematic diagram of the laser beam of FIG. 4D of conventional technology along radial section.

FIG. 2A is a cross-sectional schematic view of another embodiment of a projection laser machining system using a laser machining mask assembly of the present invention.

FIG. 2B is a schematic top view of the initial mask of the laser machining mask assembly of the embodiment of FIG. 2A.

FIG. 2C is a schematic top view of the first correction mask of the laser machining mask assembly of the embodiment of FIG. 2A.

FIG. 2D is a schematic diagram of an irradiance profile of the laser beam simulating the laser beam of the embodiment of FIG. 2A projected on a projection focal plane after propagating through the laser machining mask assembly and the projection lens.

FIG. 2E is a cross-sectional irradiance profile schematic diagram of the laser beam of FIG. 2D along X-axis section.

FIG. 2F is a cross-sectional irradiance profile schematic diagram of the laser beam of FIG. 2D along Y-axis section.

FIG. 2G is a comparison of the cross-sectional irradiance profile schematic diagram of the laser beam of FIG. 2E of the present invention along X-axis section and the cross-sectional irradiance profile schematic diagram of the laser beam of FIG. 5D of conventional technology along X-axis section.

FIG. 2H is a comparison of the cross-sectional irradiance profile schematic diagram of the laser beam of FIG. 2F of the present invention along Y-axis section and the cross-sectional irradiance profile schematic diagram of the laser beam of FIG. 5E of conventional technology along Y-axis section.

FIG. 2I is a comparison of the normalized cross-sectional irradiance profile schematic diagram of the laser beam of FIG. 2E of the present invention along X-axis section and the normalized cross-sectional irradiance profile schematic diagram of the laser beam of FIG. 5D of conventional technology along X-axis section.

FIG. 2J is a comparison of the normalized cross-sectional irradiance profile schematic diagram of the laser beam of FIG. 2F of the present invention along Y-axis section and the normalized cross-sectional irradiance profile schematic diagram of the laser beam of FIG. 5E of conventional technology along Y-axis section.

FIG. 3A is a cross-sectional schematic view of another embodiment of the laser machining mask assembly of the present invention.

FIG. 3B is a cross-sectional schematic view of another embodiment of the laser machining mask assembly of the present invention.

FIG. 3C is a cross-sectional schematic view of another embodiment of the laser machining mask assembly of the present invention.

FIGS. 3D and 3E are schematic top views of the initial mask and the first correction mask of another embodiment of the laser machining mask assembly of the present invention, respectively.

FIG. 3F is a cross-sectional schematic view of another embodiment of the laser machining mask assembly of the present invention.

FIG. 4A is a cross-sectional schematic view of an embodiment of a projection laser machining system using a laser machining mask of conventional technology.

FIG. 4B is a schematic top view of the laser machining mask of the embodiment of FIG. 4A of conventional technology.

FIG. 4C is a schematic diagram of an irradiance profile of the laser beam simulating the laser beam of the embodiment of FIG. 4A of conventional technology projected on a projection focal plane after propagating through the laser machining mask and the projection lens.

FIG. 4D is a cross-sectional irradiance profile schematic diagram of the laser beam of FIG. 4C of conventional technology along radial section.

FIG. 5A is a cross-sectional schematic view of another embodiment of a projection laser machining system using a laser machining mask of conventional technology.

FIG. 5B is a schematic top view of the laser machining mask of the embodiment of FIG. 5A of conventional technology.

FIG. 5C is a schematic diagram of an irradiance profile of the laser beam simulating the laser beam of the embodiment of FIG. 5A of conventional technology projected on a projection focal plane after propagating through the laser machining mask and the projection lens.

FIG. 5D is a cross-sectional irradiance profile schematic diagram of the laser beam of FIG. 5C of conventional technology along X-axis section.

FIG. 5E is a cross-sectional irradiance profile schematic diagram of the laser beam of FIG. 5C of conventional technology along Y-axis section.

### DETAILED DESCRIPTIONS OF PREFERRED EMBODIMENTS

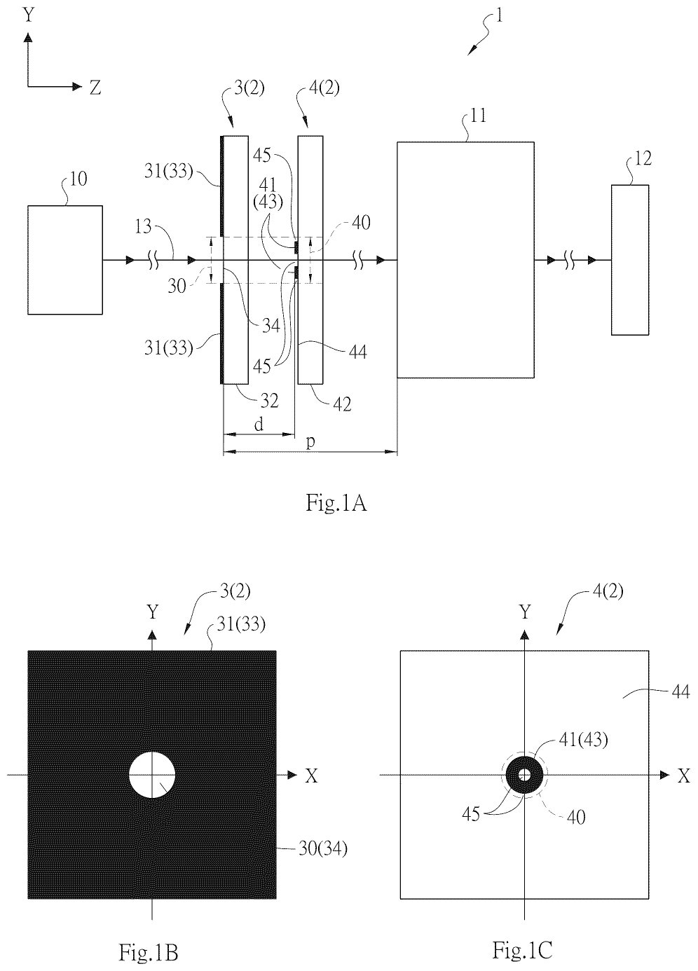

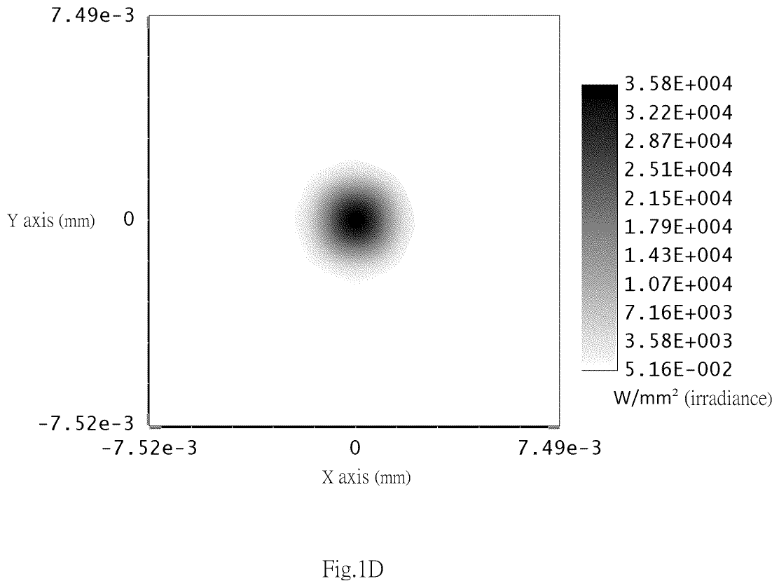

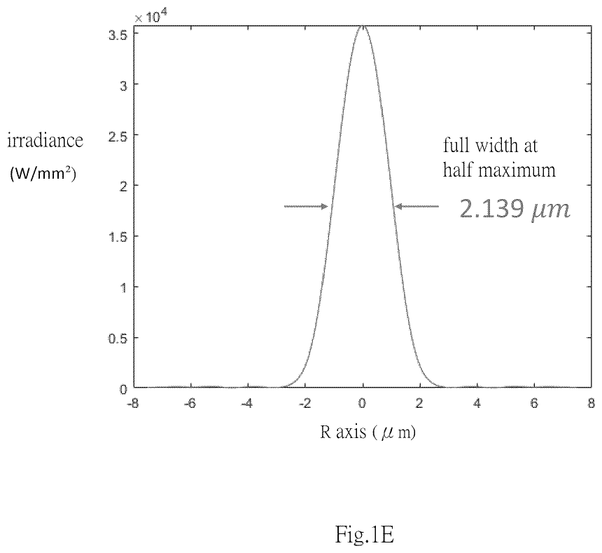

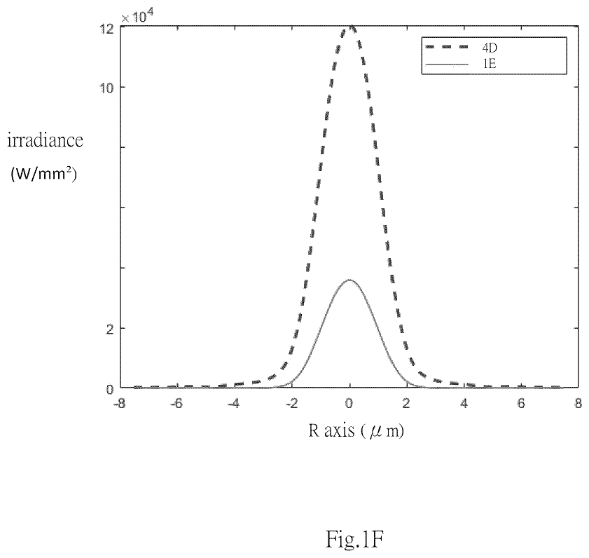

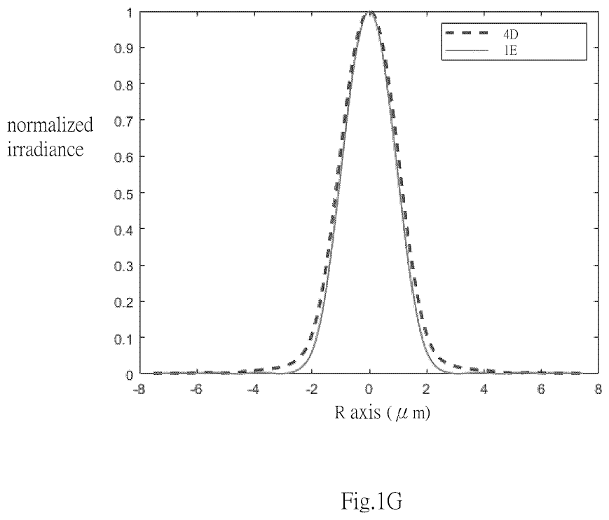

Please refer to FIG. 1A, which is a cross-sectional schematic view of an embodiment of a projection laser machining system using a laser machining mask assembly of the present invention. Please also refer to FIGS. 1B and 1C, which are schematic top views of the initial mask and the first correction mask of the laser machining mask assembly of the embodiment of FIG. 1A, respectively. A projection laser machining system 1 using a laser machining mask assembly 2 of the present invention comprises a machining laser apparatus 10, the laser machining mask assembly 2 and a projection lens 11. The laser machining mask assembly 2, the projection lens 11 and a workpiece 12 are sequentially arranged on a propagation path of a laser beam 13 generated by the machining laser apparatus 10 along a propagation direction of the laser beam 13. In current embodiment, the laser machining mask assembly 2 comprises an initial mask 3 and a first correction mask 4, wherein the first correction mask 4 is arranged between the initial mask 3 and the projection lens 11. The initial mask 3 is amplitude mask type. The initial mask 3 comprises an initial mask substrate 32 and an initial masking layer 33. The initial masking layer 33 is formed on a first surface 34 of the initial mask substrate 32. The initial mask 3 includes an initial masked region 31 where the initial masking layer 33 is formed (that is, the initial masking layer 33 of the initial mask 3 is formed within the initial masked region 31 of the initial mask 3) and an initial unmasked region 30 where the initial masking layer 33 is not formed (that is, the region outside the initial masked region 31). The initial unmasked region 30 has a shape of a circle. The first correction mask 4 comprises a first mapping region 40, wherein the first mapping region 40 of the first correction mask 4 is where the initial unmasked region 30 of the initial mask 3 mapping to the first correction mask 4 along the propagation path of the laser beam 13. The first mapping region 40 has a shape of a circle (same shape as the initial unmasked region 30), and an area of the circle of the first mapping region 40 is the same as an area of the circle of the initial unmasked region 30. The first mapping region 40 is amplitude mask type. The first correction mask 4 comprises a first correction mask substrate 42 and a first correction masking layer 43, wherein the first correction masking layer 43 is formed on a surface 44 of the first correction mask substrate 42. The first mapping region 40 includes a first mapping masked region 41 and a first mapping unmasked region 45. The first correction masking layer 43 is formed within the first mapping masked region 41 of the first mapping region 40. The first mapping unmasked region 45 is the region where the first correction masking layer 43 is not formed within the first mapping region 40 (that is, the region within the first mapping region 40 outside the first mapping masked region 41). The first mapping masked region 41 has a shape of a ring. The ring of the first mapping masked region 41 is symmetrical about a center of the circle of the first mapping region 40 (that is, symmetrical about the origin where X-axis=0 and Y-axis=0). An outer diameter of the ring of the first mapping masked region 41 is smaller than a diameter of the circle of the first mapping region 40. In current embodiment, a wavelength of the laser beam 13 generated by the machining laser apparatus 10 is 248 nm. A magnification of the projection lens 11 is 0.4 times. A diameter of the circle of the initial unmasked region 30 and the diameter of the circle of the first mapping region 40 are both equal to 7.5 μm. The outer diameter of the ring of the first mapping masked region 41 is equal to 6 μm. An inner diameter of the ring of the first mapping masked region 41 is equal to 2 μm. A mask spacing d is between the initial masking layer 33 and the first correction masking layer 43 along the propagation direction of the laser beam 13. The mask spacing d is equal to 0.5 mm. A mask-projection spacing p is between the first correction mask 4 and the projection lens 11. The mask-projection spacing p is equal to 60 mm.

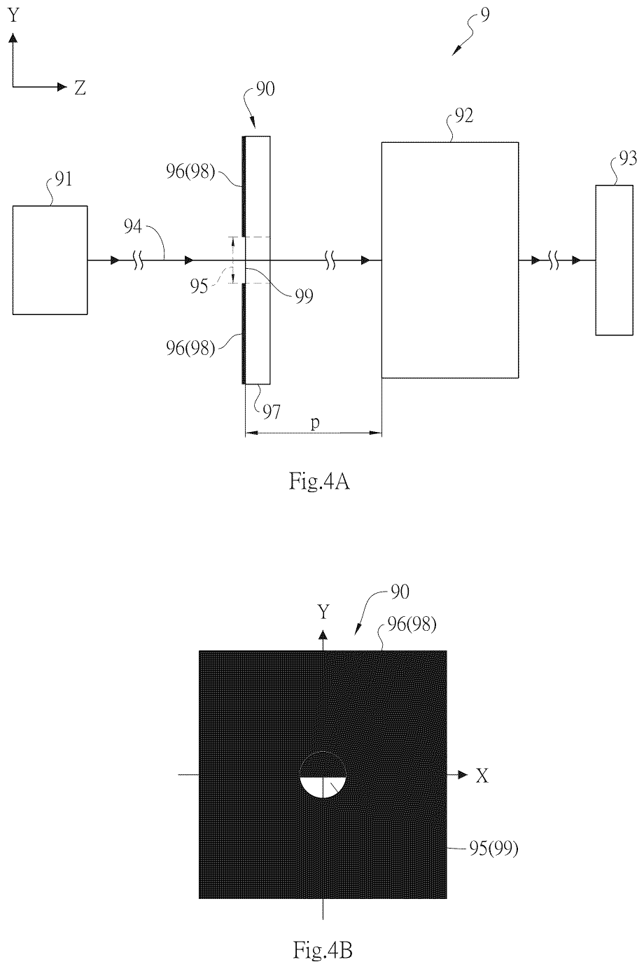

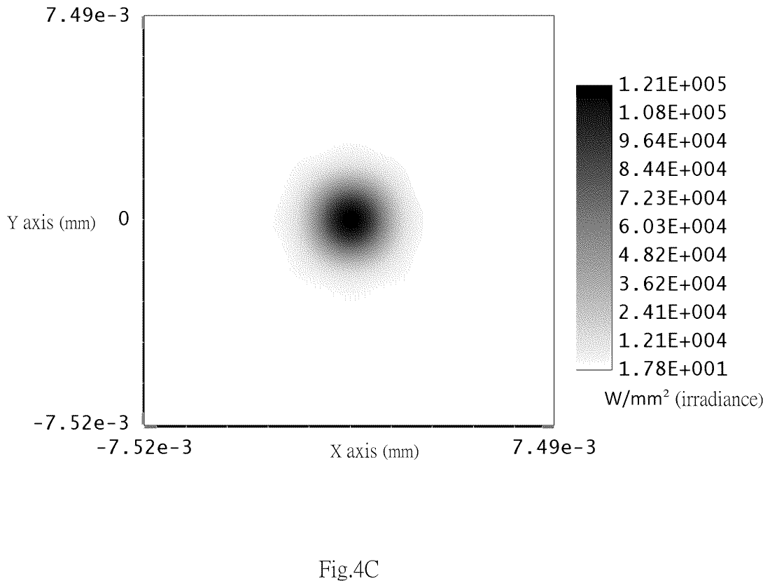

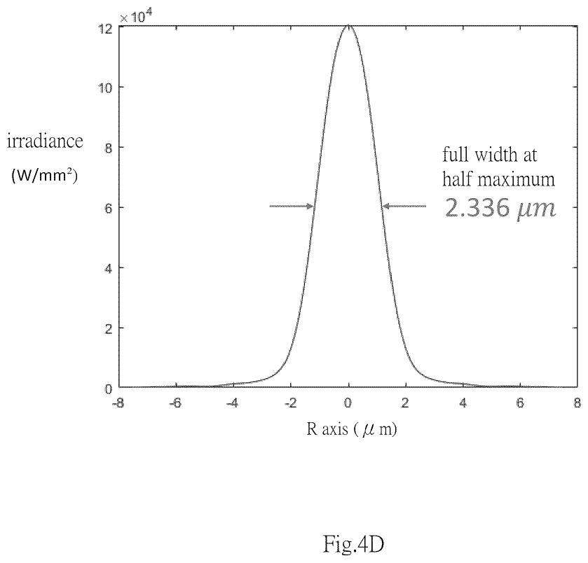

The only difference between the embodiment of FIG. 1A of the present invention and the embodiment of FIG. 4A of conventional technology is that the embodiment of FIG. 1A of the present invention has the first correction mask 4 additionally. The initial mask 3, the machining laser apparatus 10 and the projection lens 11 of the embodiment of FIG. 1A of the present invention are the same as the laser machining mask 90, the machining laser apparatus 91 and the projection lens 92 of the embodiment of FIG. 4A of conventional technology, respectively; also the parameters are the same. Please also refer to FIG. 1D, which is a schematic diagram of an irradiance profile of the laser beam simulating the laser beam of the embodiment of FIG. 1A projected on a projection focal plane after propagating through the laser machining mask assembly and the projection lens. And please also refer to FIG. 1E, which is a cross-sectional irradiance profile schematic diagram of the laser beam of FIG. 1D along radial section (R-axis passes through X-axis=0 and Y-axis=0). By simulation, after the laser beam 13 propagates through the laser machining mask assembly 2 (including the initial mask 3 and the first correction mask 4) and the projection lens 11, the laser beam 13 is projected on a projection focal plane (for example, projected on the workpiece 12), the irradiance profile of the laser beam 13 is as shown in FIG. 1D. A full width at half maximum (FWHM) of the cross-sectional irradiance profile of the laser beam of FIG. 1E of the present invention along radial section is equal to 2.139 μm which is obviously smaller than a full width at half maximum (2.336 μm) of the cross-sectional irradiance profile schematic diagram of the laser beam of FIG. 4D of conventional technology along radial section. Please also refer to FIG. 1F, which is a comparison of the cross-sectional irradiance profile schematic diagram of the laser beam of FIG. 1E of the present invention along radial section and the cross-sectional irradiance profile schematic diagram of the laser beam of FIG. 4D of conventional technology along radial section. Since the embodiment of FIG. 1A of the present invention has the additional first correction mask 4 compared to the embodiment of FIG. 4A of conventional technology; hence, when the laser beam 13 propagates through the initial unmasked region 30 of the initial mask 3 of the laser machining mask assembly 2 and then the laser beam 13 propagates through the first correction mask 4 of the laser machining mask assembly 2, the irradiance of the laser beam 13 will inevitably be decreased. Therefore, FIG. 1F shows that the irradiance of the laser beam of FIG. 1E of the present invention is obviously lower than the irradiance of the laser beam of FIG. 4D of conventional technology. Please also refer to FIG. 1G, which is a comparison of the normalized cross-sectional irradiance profile schematic diagram of the laser beam of FIG. 1E of the present invention along radial section and the normalized cross-sectional irradiance profile schematic diagram of the laser beam of FIG. 4D of conventional technology along radial section. After normalization (normalize the irradiance profile of FIG. 1E of the present invention and the irradiance profile of FIG. 4D of conventional technology), and then the comparison of them is as shown in FIG. 1G. A steepness of the normalized cross-sectional irradiance profile of the laser beam of FIG. 1E of the present invention along radial section is obviously steeper than a steepness of the normalized cross-sectional irradiance profile of the laser beam of FIG. 4D of conventional technology along radial section. Furthermore, in FIG. 1G, the diffraction pattern of the normalized cross-sectional irradiance profile of the laser beam of FIG. 1E of the present invention is obviously smaller (less than) the diffraction pattern of the normalized cross-sectional irradiance profile of the laser beam of FIG. 4D of conventional technology in the region beyond the spot central of the laser beam (for example, in the region where R-axis is smaller than −2 μm or greater than 2 μm). Hence, a beam size of the laser beam 13 projected on a projection focal plane (for example, projected on the workpiece 12) after the laser beam 13 propagating through the laser machining mask assembly 2 (including the initial mask 3 and the first correction mask 4) and the projection lens 11 can indeed be effectively controlled by using the first correction mask 4 of the embodiment of FIG. 1A of the present invention. And compared with the embodiment of FIG. 4A of conventional technology that only uses the laser machining mask 90 (equivalent to the initial mask 3 of the embodiment of FIG. 1A of the present invention), the embodiment of FIG. 1A of the present invention using the laser machining mask assembly 2 (including the initial mask 3 and the first correction mask 4) can indeed effectively reduce the diffraction pattern of the irradiance profile of the laser beam 13 projected on the projection focal plane. Moreover, the steepness of the irradiance profile of the laser beam along radial section can be increased (become steeper) and the full width at half maximum (FWHM) of the irradiance profile of the laser beam along radial section can be decreased by using the first correction mask 4 of the embodiment of FIG. 1A of the present invention. When the projection laser machining system 1 (using the laser machining mask assembly 2) of the present invention is used to perform laser drilling process on the workpiece 12, a steepness of a hole drilled by laser drilling process is relatively higher (compare with a hole drilled by the projection laser machining system 9 (using the laser machining mask 90) of the embodiment of FIG. 4A of conventional technology); hence, the formation of the hole with a wider opening and a narrower bottom can be avoided. In addition, it greatly reduces the possibility that the surface of the workpiece 12 around the opening of the hole drilled by laser drilling process will be damaged by the diffraction pattern of the laser beam 13. Therefore, the laser machining mask assembly 2 of the embodiment of FIG. 1A of the present invention (including the initial mask 3 of the embodiment of FIG. 1B and the first correction mask 4 of the embodiment of FIG. 1C) is suitable for use in, for example, laser drilling processes, especially circular symmetrical laser drill processes. Moreover, due to the characteristics of circular symmetry, it is also suitable for use in laser scribing processes, such as scribing grooves along any arbitrary direction while processing; or it is suitable for use in laser patterning processes, such as changing directions while processing to create laser processed patterns by laser patterning processes. The laser drilling process in the specification of the present invention may refer to the process of laser drilling a hole on the workpiece 12 with a depth less than a thickness of the workpiece 12, or may refer to the process of laser drilling a through hole on the workpiece 12, wherein the through hole penetrates the workpiece 12. The laser scribing process in the specification of the present invention may refer to the process of laser scribing a groove on the workpiece 12 with a depth less than the thickness of the workpiece 12, or may refer to the process of laser scribing a groove on the workpiece 12, wherein the groove penetrates the workpiece 12.

In some embodiments, the diameter of the circle of the initial unmasked region 30 and the diameter of the circle of the first mapping region 40 are both greater than or equal to 10 times a wavelength of the laser beam 13 and smaller than or equal to 91 times the wavelength of the laser beam 13. In some embodiments, the mask spacing d between the initial masking layer 33 and the first correction masking layer 43 along the propagation direction of the laser beam 13 is greater than or equal to 403 times the wavelength of the laser beam 13 and smaller than or equal to 24194 times the wavelength of the laser beam 13.

In some embodiments, a ratio of the inner diameter of the ring of the first mapping masked region 41 to the diameter of the circle of the first mapping region 40 (the diameter of the circle of the initial unmasked region 30) is between 2:15 and 2:5; a ratio of the outer diameter of the ring of the first mapping masked region 41 to the diameter of the circle of the first mapping region 40 (the diameter of the circle of the initial unmasked region 30) is between 2:3 and 14:15.

In some embodiments, the first correction mask 4 is amplitude mask type. In some other embodiments, the first correction mask 4 is phase mask type.

In some embodiments, the initial mask 3 is arranged between the first correction mask 4 and the projection lens 11.

In some embodiments, the initial mask 3 comprises a plurality of initial unmasked regions 30, the first correction mask 4 comprises a plurality of first mapping regions 40, wherein each of the first mapping regions 40 of first correction mask 4 is where a corresponding one of the initial unmasked regions 30 of the initial mask 3 mapping to the first correction mask 4 along the propagation path of the laser beam 13.

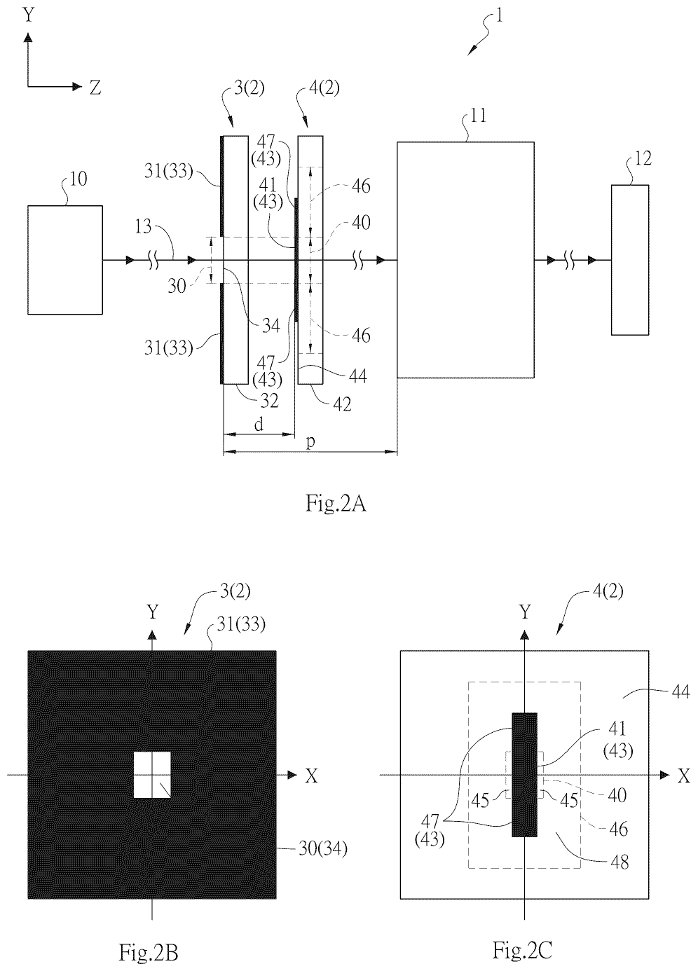

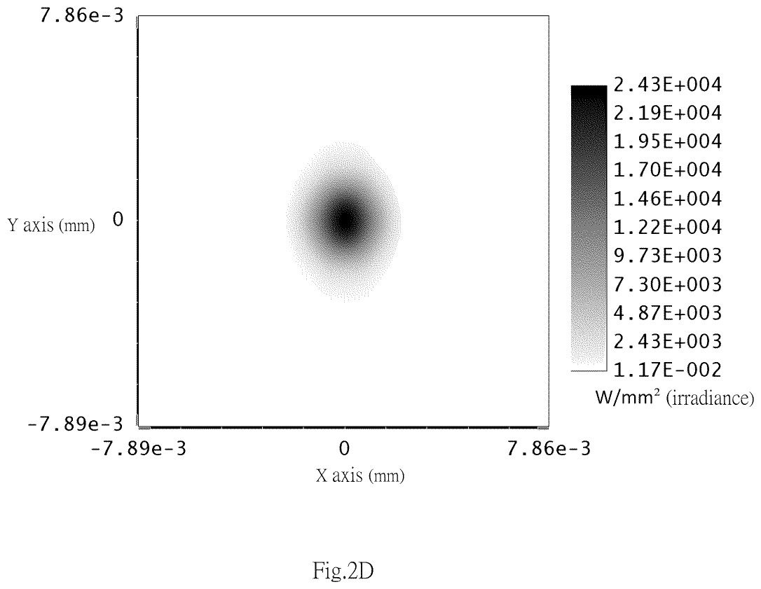

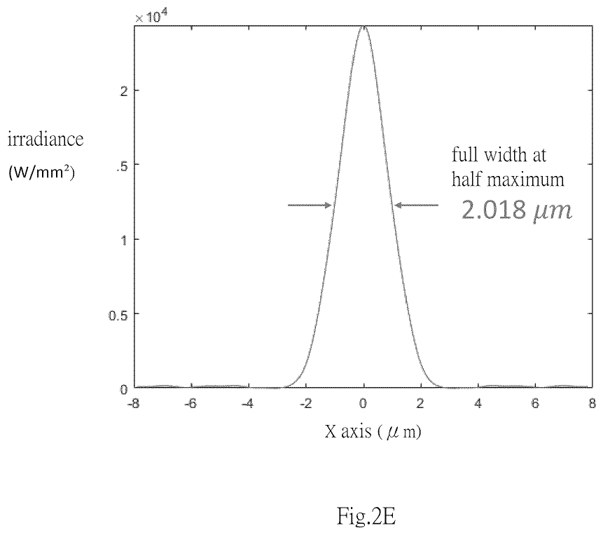

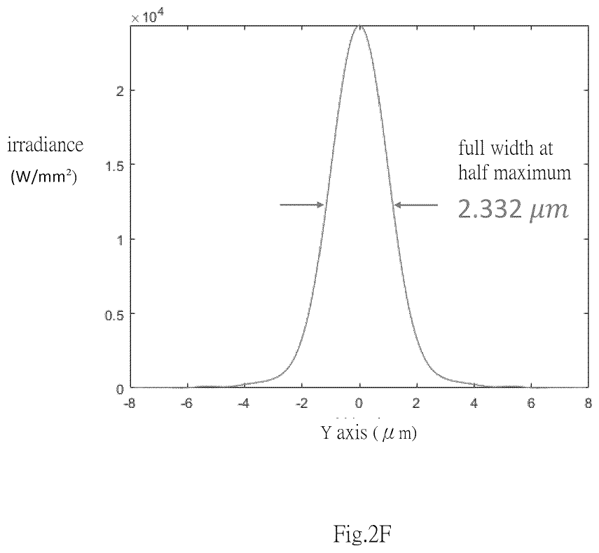

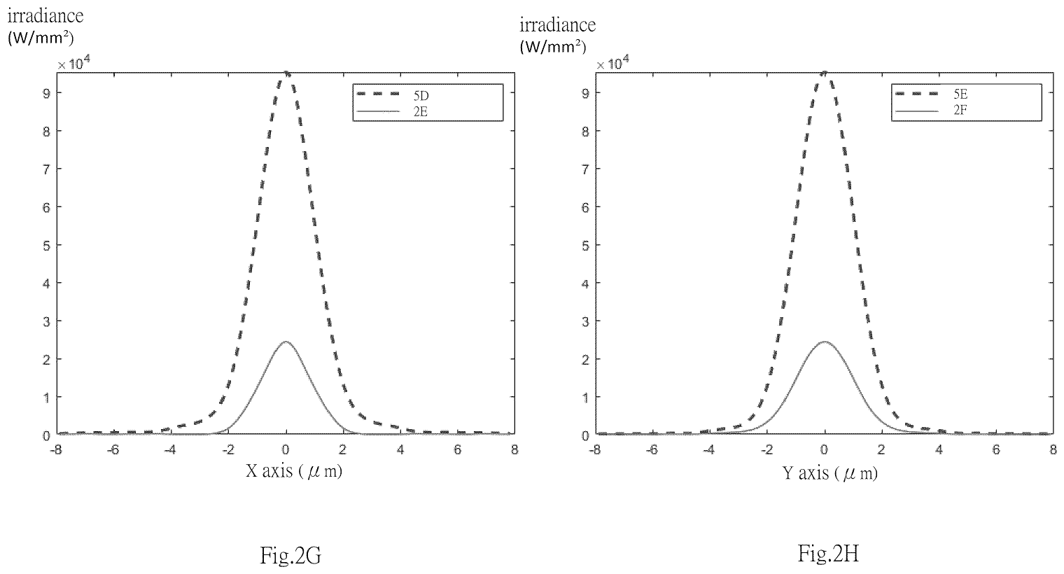

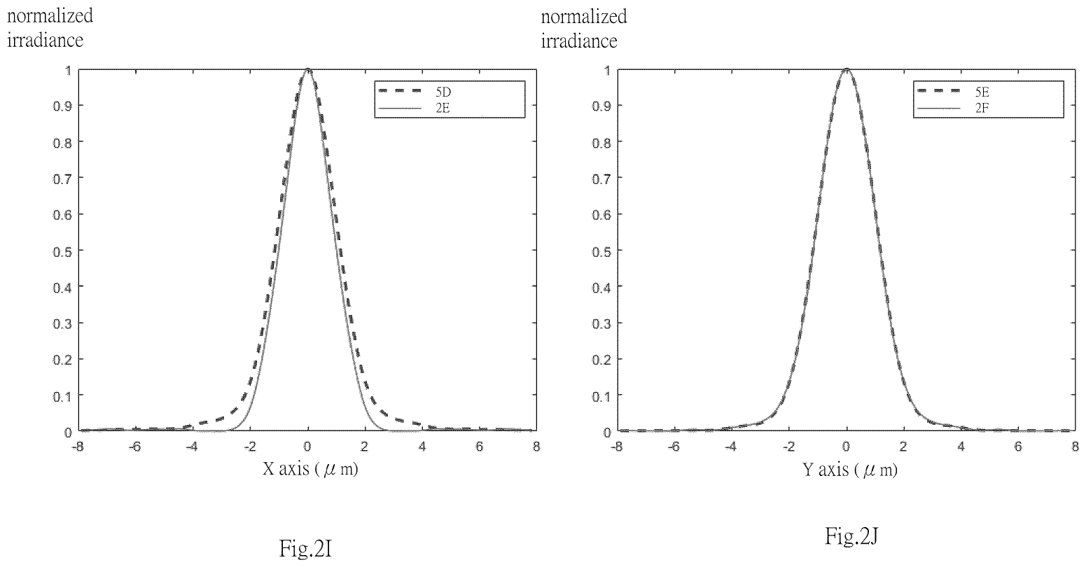

Please refer to FIG. 2A, which is a cross-sectional schematic view of another embodiment of a projection laser machining system using a laser machining mask assembly of the present invention. Please also refer to FIGS. 2B and 2C, which are schematic top views of the initial mask and the first correction mask of the laser machining mask assembly of the embodiment of FIG. 2A, respectively. A projection laser machining system 1 using a laser machining mask assembly 2 of the present invention comprises a machining laser apparatus 10, the laser machining mask assembly 2 and a projection lens 11. The laser machining mask assembly 2, the projection lens 11 and a workpiece 12 are sequentially arranged on a propagation path of a laser beam 13 generated by the machining laser apparatus 10 along a propagation direction of the laser beam 13. In current embodiment, the laser machining mask assembly 2 comprises an initial mask 3 and a first correction mask 4, wherein the first correction mask 4 is arranged between the initial mask 3 and the projection lens 11. The initial mask 3 is amplitude mask type. The initial mask 3 comprises an initial mask substrate 32 and an initial masking layer 33. The initial masking layer 33 is formed on a first surface 34 of the initial mask substrate 32. The initial mask 3 includes an initial masked region 31 where the initial masking layer 33 is formed (that is, the initial masking layer 33 of the initial mask 3 is formed within the initial masked region 31 of the initial mask 3) and an initial unmasked region 30 where the initial masking layer 33 is not formed (that is, the region outside the initial masked region 31). The initial unmasked region 30 has a shape of a rectangle. The first correction mask 4 comprises a first mapping region 40 and a surrounding region 46, wherein the first mapping region 40 of the first correction mask 4 is where the initial unmasked region 30 of the initial mask 3 mapping to the first correction mask 4 along the propagation path of the laser beam 13; while the surrounding region 46 surrounds the first mapping region 40. The first mapping region 40 has a shape of a rectangle (same shape as the initial unmasked region 30), and an area of the rectangle of the first mapping region 40 is the same as an area of the rectangle of the initial unmasked region 30 (the rectangle of the first mapping region 40 and the rectangle of the initial unmasked region 30 are identical). The first mapping region 40 and the surrounding region 46 are both amplitude mask type. The first mapping region 40 includes a first mapping masked region 41 and a first mapping unmasked region 45. The surrounding region 46 includes a surrounding masked region 47 and a surrounding unmasked region 48. The first mapping masked region 41 of first mapping region 40 is connected to the surrounding masked region 47 of the surrounding region 46 to form a rectangle (hereinafter, a mapping rectangle is defined as the rectangle of the first mapping region 40; while a connected rectangle is defined as the rectangle formed by connecting the first mapping masked region 41 of first mapping region 40 and the surrounding masked region 47 of the surrounding region 46). The first correction mask 4 comprises a first correction mask substrate 42 and a first correction masking layer 43, wherein the first correction masking layer 43 is formed on a surface 44 of the first correction mask substrate 42. The region where the first correction masking layer 43 is formed on the surface 44 of the first correction mask substrate 42 includes the first mapping masked region 41 of the first mapping region 40 and the surrounding masked region 47 of the surrounding region 46 (that is, the region of the connected rectangle). The first mapping unmasked region 45 is the region where the first correction masking layer 43 is not formed on the surface 44 of the first correction mask substrate 42 within the first mapping region 40 (that is, the region within the first mapping region 40 outside the first mapping masked region 41). The surrounding unmasked region 48 is the region where the first correction masking layer 43 is not formed on the surface 44 of the first correction mask substrate 42 within the surrounding region 46 (that is, the region within the surrounding region 46 outside the surrounding masked region 47). A geometric center of the mapping rectangle is coincident with a geometric center of the connected rectangle (both are located at the origin where X-axis=0 and Y-axis=0), and a longer side of the mapping rectangle is parallel with a longer side of the connected rectangle (a shorter side of the mapping rectangle is also parallel with a shorter side of the connected rectangle). The longer side of the mapping rectangle is smaller than the longer side of the connected rectangle, and the shorter side of the mapping rectangle is greater than the shorter side of the connected rectangle. In current embodiment, a wavelength of the laser beam 13 generated by the machining laser apparatus 10 is 248 nm. A magnification of the projection lens 11 is 0.4 times. A longer side of the rectangle of the initial unmasked region 30 and the longer side of the mapping rectangle (the rectangle of the first mapping region 40) are both equal to 7.5 μm. A shorter side of the rectangle of the initial unmasked region 30 and the shorter side of the mapping rectangle (the rectangle of the first mapping region 40) are both equal to 6 μm. The longer side of the connected rectangle (the rectangle formed by connecting the first mapping masked region 41 and the surrounding masked region 47) is equal to 20 μm. The shorter side of the connected rectangle (the rectangle formed by connecting the first mapping masked region 41 and the surrounding masked region 47) is equal to 4 μm. A mask spacing d is between the initial masking layer 33 and the first correction masking layer 43 along the propagation direction of the laser beam 13. The mask spacing d is equal to 0.5 mm. A mask-projection spacing p is between the first correction mask 4 and the projection lens 11. The mask-projection spacing p is equal to 60 mm.

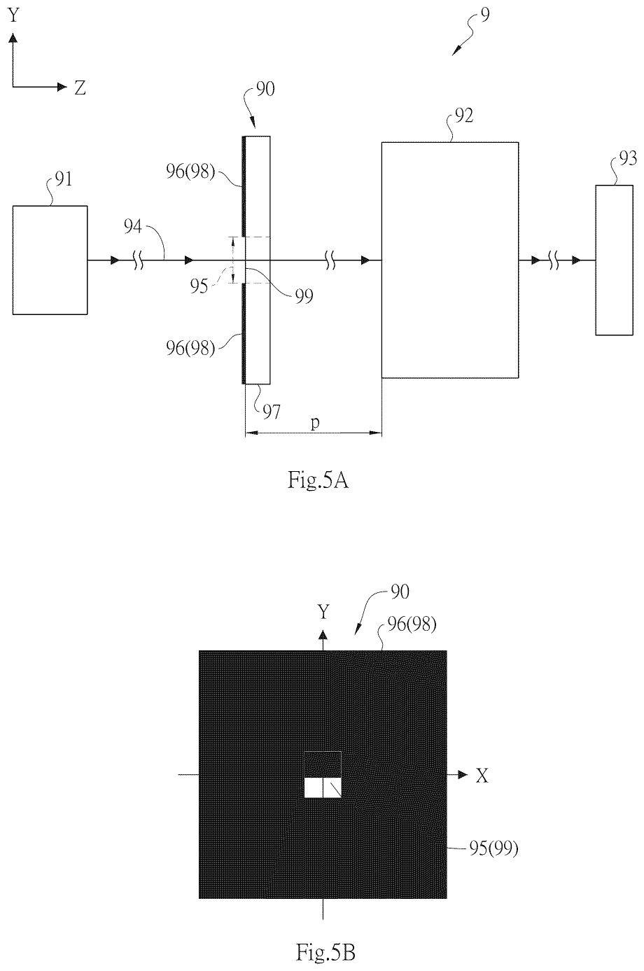

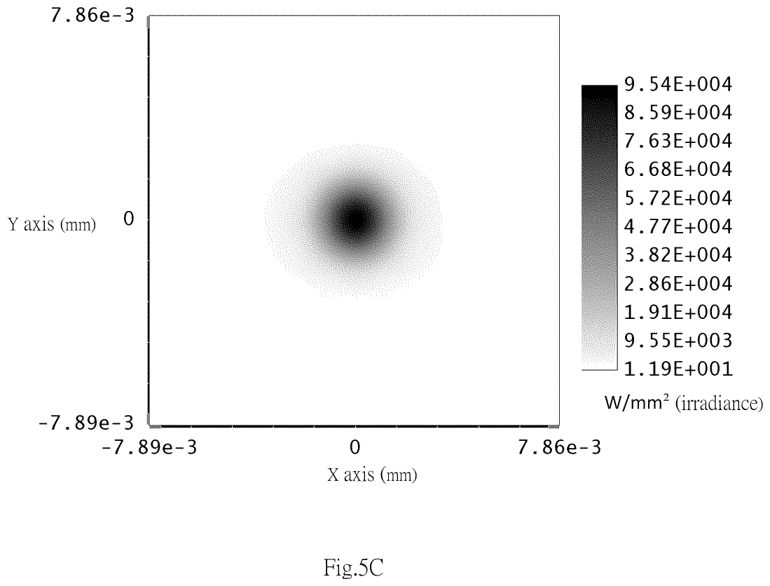

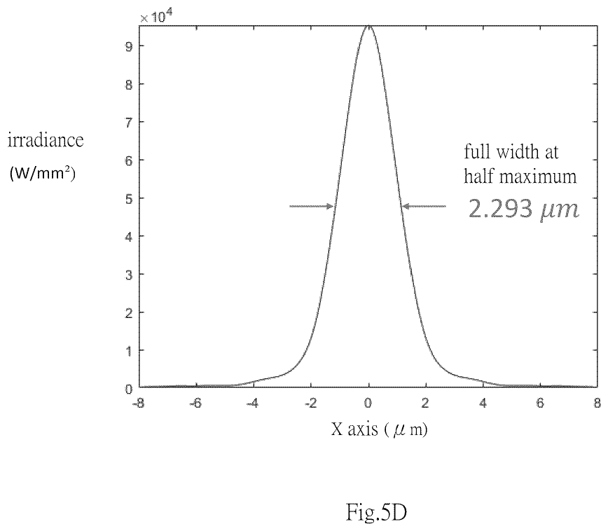

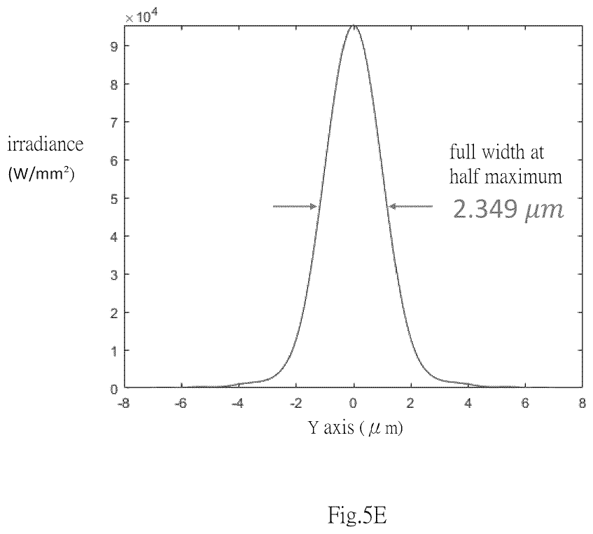

The only difference between the embodiment of FIG. 2A of the present invention and the embodiment of FIG. 5A of conventional technology is that the embodiment of FIG. 2A of the present invention has the first correction mask 4 additionally. The initial mask 3, the machining laser apparatus 10 and the projection lens 11 of the embodiment of FIG. 2A of the present invention are the same as the laser machining mask 90, the machining laser apparatus 91 and the projection lens 92 of the embodiment of FIG. 5A of conventional technology, respectively; also the parameters are the same. Please also refer to FIG. 2D, which is a schematic diagram of an irradiance profile of the laser beam simulating the laser beam of the embodiment of FIG. 2A projected on a projection focal plane after propagating through the laser machining mask assembly and the projection lens. And please also refer to FIGS. 2E and 2F, which are cross-sectional irradiance profile schematic diagrams of the laser beam of FIG. 2D along X-axis section and along Y-axis section, respectively. By simulation, after the laser beam 13 propagates through the laser machining mask assembly 2 (including the initial mask 3 and the first correction mask 4) and the projection lens 11, the laser beam 13 is projected on a projection focal plane (for example, projected on the workpiece 12), the irradiance profile of the laser beam 13 is as shown in FIG. 2D. A full width at half maximum (FWHM) of the cross-sectional irradiance profile of the laser beam of FIG. 2E of the present invention along X-axis section is equal to 2.018 μm which is obviously smaller than a full width at half maximum (2.293 μm) of the cross-sectional irradiance profile schematic diagram of the laser beam of FIG. 5D of conventional technology along X-axis section; while a full width at half maximum (FWHM) of the cross-sectional irradiance profile of the laser beam of FIG. 2F of the present invention along Y-axis section is equal to 2.332 μm which is only slightly smaller than a full width at half maximum (2.349 μm) of the cross-sectional irradiance profile schematic diagram of the laser beam of FIG. 5E of conventional technology along Y-axis section. Please also refer to FIG. 2G, which is a comparison of the cross-sectional irradiance profile schematic diagram of the laser beam of FIG. 2E of the present invention along X-axis section and the cross-sectional irradiance profile schematic diagram of the laser beam of FIG. 5D of conventional technology along X-axis section. Please also refer to FIG. 2H, which is a comparison of the cross-sectional irradiance profile schematic diagram of the laser beam of FIG. 2F of the present invention along Y-axis section and the cross-sectional irradiance profile schematic diagram of the laser beam of FIG. 5E of conventional technology along Y-axis section. Since the embodiment of FIG. 2A of the present invention has the additional first correction mask 4 compared to the embodiment of FIG. 5A of conventional technology; hence, when the laser beam 13 propagates through the initial unmasked region 30 of the initial mask 3 of the laser machining mask assembly 2 and then the laser beam 13 propagates through the first correction mask 4 of the laser machining mask assembly 2, the irradiance of the laser beam 13 will inevitably be decreased. Therefore, FIGS. 2G and 2H respectively show that the irradiance of the laser beam of FIGS. 2E and 2F of the present invention are obviously lower than the irradiance of the laser beam of FIGS. 5D and 5E of conventional technology. Please also refer to FIG. 2I, which is a comparison of the normalized cross-sectional irradiance profile schematic diagram of the laser beam of FIG. 2E of the present invention along X-axis section and the normalized cross-sectional irradiance profile schematic diagram of the laser beam of FIG. 5D of conventional technology along X-axis section. Please also refer to FIG. 2J, which is a comparison of the normalized cross-sectional irradiance profile schematic diagram of the laser beam of FIG. 2F of the present invention along Y-axis section and the normalized cross-sectional irradiance profile schematic diagram of the laser beam of FIG. 5E of conventional technology along Y-axis section. After normalization (normalize the irradiance profile of FIG. 2E of the present invention and the irradiance profile of FIG. 5D of conventional technology; and normalize the irradiance profile of FIG. 2F of the present invention and the irradiance profile of FIG. 5E of conventional technology), and then the comparison of them are as shown in FIGS. 21 and 2J. In FIG. 2I, a steepness of the normalized cross-sectional irradiance profile of the laser beam of FIG. 2E of the present invention along X-axis section is obviously steeper than a steepness of the normalized cross-sectional irradiance profile of the laser beam of FIG. 5D of conventional technology along X-axis section. Furthermore, in FIG. 2I, the diffraction pattern of the normalized cross-sectional irradiance profile of the laser beam of FIG. 2E of the present invention along X-axis section is obviously smaller (less than) the diffraction pattern of the normalized cross-sectional irradiance profile of the laser beam of FIG. 5D of conventional technology along X-axis section in the region beyond the spot central of the laser beam along X-axis section (for example, in the region where X-axis is smaller than −2 μm or greater than 2 μm). However, in FIG. 2J, a steepness of the normalized cross-sectional irradiance profile of the laser beam of FIG. 2F of the present invention along Y-axis section is only slightly steeper than a steepness of the normalized cross-sectional irradiance profile of the laser beam of FIG. 5E of conventional technology along Y-axis section (the full width at half maximum of the normalized cross-sectional irradiance profile of the laser beam of FIG. 2F of the present invention along Y-axis section is equal to 2.332 μm which is slightly smaller than the full width at half maximum (2.349 μm) of the normalized cross-sectional irradiance profile schematic diagram of the laser beam of FIG. 5E of conventional technology along Y-axis section); and the diffraction pattern of the normalized cross-sectional irradiance profile of the laser beam of FIG. 2F of the present invention along Y-axis section is similar to the diffraction pattern of the normalized cross-sectional irradiance profile of the laser beam of FIG. 5E of conventional technology along Y-axis section in the region beyond the spot central of the laser beam along Y-axis section (for example, in the region where Y-axis is smaller than −2 μm or greater than 2 μm). Hence, a beam size of the laser beam 13 projected on a projection focal plane (for example, projected on the workpiece 12) along X-axis section after the laser beam 13 propagating through the laser machining mask assembly 2 (including the initial mask 3 and the first correction mask 4) and the projection lens 11 can indeed be effectively controlled by using the first correction mask 4 of the embodiment of FIG. 2A of the present invention. And compared with the embodiment of FIG. 5A of conventional technology that only uses the laser machining mask 90 (equivalent to the initial mask 3 of the embodiment of FIG. 2A of the present invention), the embodiment of FIG. 2A of the present invention using the laser machining mask assembly 2 (including the initial mask 3 and the first correction mask 4) can indeed effectively reduce the diffraction pattern of the irradiance profile of the laser beam 13 projected on the projection focal plane along X-axis section (that is, a beam size of the laser beam 13 projected on the projection focal plane along X-axis section can indeed be effectively controlled). Moreover, the steepness of the irradiance profile of the laser beam along X-axis section can be increased (become steeper) and the full width at half maximum (FWHM) of the irradiance profile of the laser beam along X-axis section can be decreased by using the first correction mask 4 of the embodiment of FIG. 2A of the present invention. However, by using the first correction mask 4 of the embodiment of FIG. 2A of the present invention, it is relatively limited in controlling a beam size of the laser beam 13 projected on the projection focal plane along Y-axis section after the laser beam 13 propagating through the laser machining mask assembly 2 (including the initial mask 3 and the first correction mask 4) and the projection lens 11. And the embodiment of FIG. 2A of the present invention using the laser machining mask assembly 2 (including the initial mask 3 and the first correction mask 4) is relatively limited in reducing the diffraction pattern of the irradiance profile of the laser beam 13 projected on the projection focal plane along Y-axis section (that is, it is relatively limited in controlling a beam size of the laser beam 13 projected on the projection focal plane along Y-axis section). Moreover, it is relatively limited in increasing the steepness (become steeper) of the irradiance profile of the laser beam along Y-axis section and relatively limited in decreasing the full width at half maximum (FWHM) of the irradiance profile of the laser beam along Y-axis section by using the first correction mask 4 of the embodiment of FIG. 2A of the present invention. Therefore, when using the projection laser machining system 1 (using the laser machining mask assembly 2) of the present invention to perform laser scribing process on the workpiece 12, when the laser beam 13 is moving along Y-axis while performing laser scribing process to scribe a long groove along Y-axis, the along Y-axis long groove scribed by laser scribing process has a relatively higher steepness of a cross-section of the long groove along X-axis section (compare with a long groove scribed by the projection laser machining system 9 (using the laser machining mask 90) of the embodiment of FIG. 5A of conventional technology); hence, the formation of the along Y-axis long groove with a wider opening along X-axis section and a narrower bottom along X-axis section can be avoided. In addition, it greatly reduces the possibility that the surface of the workpiece 12 around the opening of the long groove scribed by laser scribing process along X-axis section will be damaged by the diffraction pattern of the laser beam 13. Therefore, the laser machining mask assembly 2 of the embodiment of FIG. 2A of the present invention (including the initial mask 3 of the embodiment of FIG. 2B and the first correction mask 4 of the embodiment of FIG. 2C) is suitable for use in laser scribing process, such as scribing along Y-axis to scribe a long groove along Y-axis while processing.

In some embodiments, the longer side of the rectangle of the initial unmasked region 30 and the longer side of the mapping rectangle are both greater than or equal to 10 times a wavelength of the laser beam 13 and smaller than or equal to 91 times the wavelength of the laser beam 13; the shorter side of the rectangle of the initial unmasked region 30 and the shorter side of the mapping rectangle are both greater than or equal to 8 times the wavelength of the laser beam 13 and smaller than or equal to 73 times the wavelength of the laser beam 13. In some embodiments, the mask spacing d between the initial masking layer 33 and the first correction masking layer 43 along the propagation direction of the laser beam 13 is greater than or equal to 403 times the wavelength of the laser beam 13 and smaller than or equal to 24194 times the wavelength of the laser beam 13.

In some embodiments, a ratio of the longer side of the rectangle of the initial unmasked region 30 (the longer side of the mapping rectangle) to the longer side of the connected rectangle is between 5:12 and 15:44; a ratio of the shorter side of the rectangle of the initial unmasked region 30 (the shorter side of the mapping rectangle) to the shorter side of the connected rectangle is between 2:1 and 6:5.

In some embodiments, the initial mask 3 is amplitude mask type and the first correction mask 4 is amplitude mask type. In some other embodiments, the initial mask 3 is amplitude mask type and the first correction mask 4 is phase mask type. In some other embodiments, the initial mask 3 is amplitude mask type and the first mapping region 40 and the surrounding region 46 are both phase mask type.

In some embodiments, the initial mask 3 is arranged between the first correction mask 4 and the projection lens 11.

In some embodiments, the initial mask 3 comprises a plurality of initial unmasked regions 30, the first correction mask 4 comprises a plurality of first mapping regions 40, wherein each of the first mapping regions 40 of first correction mask 4 is where a corresponding one of the initial unmasked regions 30 of the initial mask 3 mapping to the first correction mask 4 along the propagation path of the laser beam 13. In some other embodiments, the initial mask 3 comprises a plurality of initial unmasked regions 30, the first correction mask 4 comprises a plurality of first mapping regions 40 and a plurality of surrounding regions 46, wherein each of the first mapping regions 40 of the first correction mask 4 is where a corresponding one of the initial unmasked regions 30 of the initial mask 3 mapping to the first correction mask 4 along the propagation path of the laser beam 13, wherein the plurality of first mapping regions 40 is corresponding to the plurality of surrounding regions 46 respectively (each of the surrounding regions 46 surrounds a corresponding one of the first mapping regions 40). In some other embodiments, the initial mask 3 comprises a plurality of initial unmasked regions 30, the first correction mask 4 comprises a plurality of first mapping regions 40 and a plurality of surrounding regions 46, wherein each of the first mapping regions 40 of first correction mask 4 is where a corresponding one of the initial unmasked regions 30 of the initial mask 3 mapping to the first correction mask 4 along the propagation path of the laser beam 13, wherein at least some of the first mapping regions 40 are corresponding to the plurality of surrounding regions 46 respectively (for example, there are four surrounding regions 46 and ten first mapping regions 40; four of the ten first mapping regions 40 are corresponding to the four surrounding regions 46 respectively and are surrounded by the four surrounding regions 46 respectively).

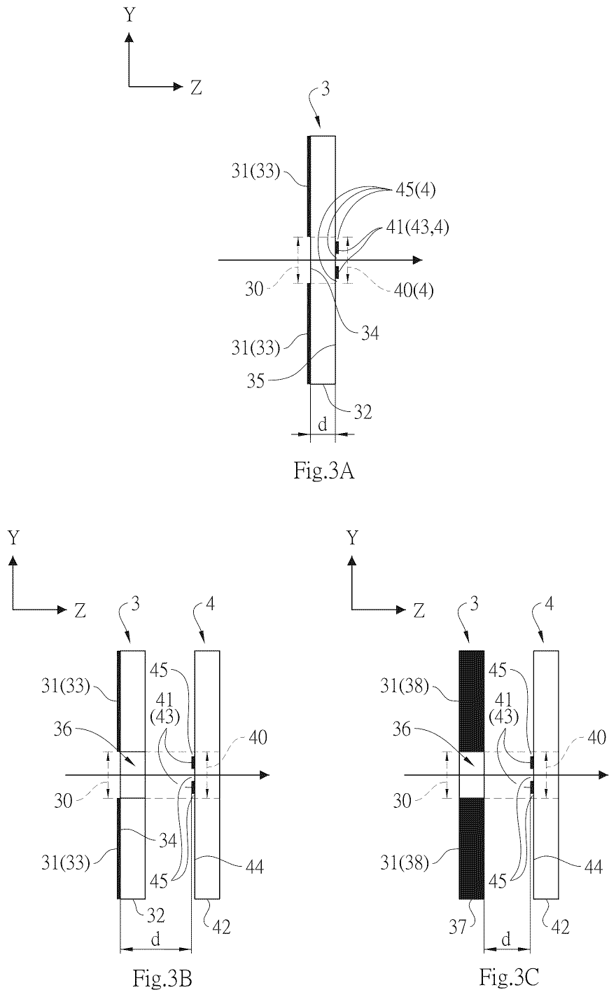

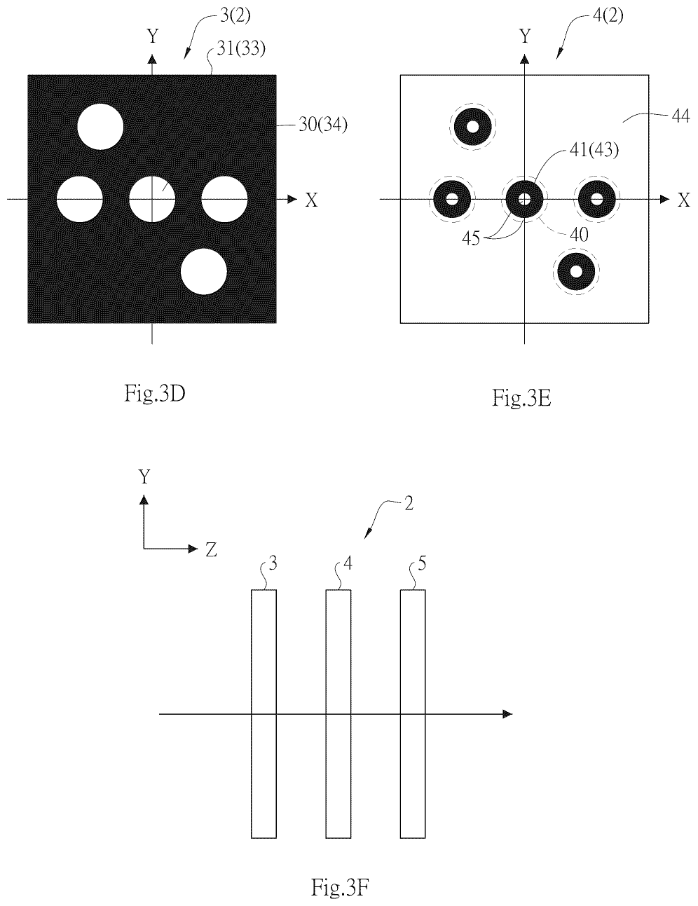

Please refer to FIG. 3A, which is a cross-sectional schematic view of another embodiment of the laser machining mask assembly of the present invention. In current embodiment, the laser machining mask assembly 2 comprises an initial mask 3 and a first correction mask 4. The initial mask 3 is amplitude mask type. The initial mask 3 comprises an initial mask substrate 32 and an initial masking layer 33. The initial masking layer 33 is formed on a first surface 34 of the initial mask substrate 32. The initial mask 3 includes an initial masked region 31 where the initial masking layer 33 is formed (that is, the initial masking layer 33 of the initial mask 3 is formed within the initial masked region 31 of the initial mask 3) and an initial unmasked region 30 where the initial masking layer 33 is not formed (that is, the region outside the initial masked region 31). The initial unmasked region 30 has a shape of a circle. The first correction mask 4 comprises a first mapping region 40, wherein the first mapping region 40 of the first correction mask 4 is where the initial unmasked region 30 of the initial mask 3 mapping to the first correction mask 4 along the propagation path of the laser beam 13. The first mapping region 40 has a shape of a circle (same shape as the initial unmasked region 30), and an area of the circle of the first mapping region 40 is the same as an area of the circle of the initial unmasked region 30. The first mapping region 40 is amplitude mask type. The first correction mask 4 comprises a first correction masking layer 43, wherein the first correction masking layer 43 of the first correction mask 4 is formed on a second surface 35 of the initial mask substrate 32 of the initial mask 3 (the second surface 35 of the initial mask substrate 32 is relative to the first surface 34 of the initial mask substrate 32 along the propagation path of the laser beam 13), such that the first correction mask 4 is arranged between the initial mask 3 and the projection lens 11. The first mapping region 40 includes a first mapping masked region 41 and a first mapping unmasked region 45. In current embodiment, the first correction masking layer 43 is the first mapping masked region 41 of the first mapping region 40. The first mapping unmasked region 45 is the region where the first correction masking layer 43 is not formed within the first mapping region 40 (that is, the region within the first mapping region 40 outside the first mapping masked region 41). The first mapping masked region 41 has a shape of a ring. The ring of the first mapping masked region 41 is symmetrical about a center of the circle of the first mapping region 40 (that is, symmetrical about the origin where X-axis=0 and Y-axis=0). An outer diameter of the ring of the first mapping masked region 41 is smaller than a diameter of the circle of the first mapping region 40. A mask spacing d is between the initial masking layer 33 and the first correction masking layer 43 along the propagation direction of the laser beam 13, wherein the mask spacing d is equal to a thickness of the initial mask substrate 32. The mask spacing d can be controlled by choosing the thickness of the initial mask substrate 32.

Please refer to FIG. 3B, which is a cross-sectional schematic view of another embodiment of the laser machining mask assembly of the present invention. The main structure of the laser machining mask assembly 2 (including the initial mask 3 and the first correction mask 4) of the embodiment of FIG. 3B is basically the same as the structure of the laser machining mask assembly 2 of the embodiment of FIGS. 1A, 1B and 1C, except that the initial mask substrate 32 of the initial mask 3 has a penetrating through region 36, wherein the penetrating through region 36 penetrates through the initial mask substrate 32 along the propagation direction of the laser beam 13, wherein the penetrating through region 36 of the initial mask substrate 32 of the initial mask 3 is the initial unmasked region 30 of the initial mask 3.

In some embodiments, the initial mask substrate 32 of the initial mask 3 has a plurality of penetrating through regions 36, wherein each of the penetrating through regions 36 penetrates through the initial mask substrate 32 along the propagation direction of the laser beam 13, wherein each of the penetrating through regions 36 is an initial unmasked region 30 of the initial mask 3.

Please refer to FIG. 3C, which is a cross-sectional schematic view of another embodiment of the laser machining mask assembly of the present invention. In current embodiment, the laser machining mask assembly 2 comprises an initial mask 3 and a first correction mask 4, wherein the first correction mask 4 is arranged between the initial mask 3 and the projection lens 11. The structure of the first correction mask 4 of the embodiment of FIG. 3C is exactly the same as the structure of the first correction mask 4 of the embodiment of FIGS. 1A and 1C. The initial mask 3 is amplitude mask type. The initial mask 3 comprises an initial mask base 37. The initial mask base 37 has a penetrating through region 36 and a non-penetrating region 38. The penetrating through region 36 penetrates through the initial mask base 37 along the propagation direction of the laser beam 13. The penetrating through region 36 of the initial mask base 37 of the initial mask 3 is the initial unmasked region 30 of the initial mask 3. The non-penetrating region 38 of the initial mask base 37 of the initial mask 3 is the initial masked region 31 of the initial mask 3. The initial unmasked region 30 (the penetrating through region 36) has a shape of a circle (the same shape as the first mapping region 40), wherein an area of the circle of the initial unmasked region 30 (the penetrating through region 36) is the same as the area of the circle of the first mapping region 40. In some embodiments, a diameter of the circle of the initial unmasked region 30 (the penetrating through region 36) and the diameter of the circle of the first mapping region 40 are both greater than or equal to 2.5 μm and smaller than or equal to 22.5 μm. In some embodiments, a mask spacing d is between the initial masked region 31 (non-penetrating region 38) and the first correction masking layer 43 along the propagation direction of the laser beam 13. The mask spacing d is greater than or equal to 0.1 mm and smaller than or equal to 6 mm.

In some embodiments, the initial mask base 37 of the initial mask 3 has a plurality of penetrating through regions 36 and a non-penetrating region 38, wherein each of the penetrating through regions 36 penetrates through the initial mask base 37 along the propagation direction of the laser beam 13, wherein each of the penetrating through regions 36 is an initial unmasked region 30 of the initial mask 3. The non-penetrating region 38 of the initial mask base 37 of the initial mask 3 is the initial masked region 31 of the initial mask 3.

Please refer to FIGS. 3D and 3E, which are schematic top views of the initial mask and the first correction mask of another embodiment of the laser machining mask assembly of the present invention, respectively. In current embodiment, the laser machining mask assembly 2 comprises an initial mask 3 and a first correction mask 4. The initial mask 3 comprises an initial masked region 31 and five initial unmasked regions 30. Each of the initial unmasked regions 30 has a shape of a circle. The first correction mask 4 comprises five first mapping regions 40, wherein each of the first mapping regions 40 is where a corresponding one of the initial unmasked regions 30 of the initial mask 3 mapping to the first correction mask 4 along the propagation path of the laser beam 13. Each of the first mapping regions 40 has a shape of a circle (same shape as the corresponding one of the initial unmasked regions 30). An area of the circle of each of the first mapping regions 40 is the same as an area of the circle of the corresponding one of the initial unmasked regions 30. The first mapping regions are amplitude mask type. Each of the first mapping regions 40 includes a first mapping masked region 41 and a first mapping unmasked region 45. The first mapping masked region 41 has a shape of a ring. The ring of the first mapping masked region 41 is symmetrical about a center of the circle of the first mapping region 40 (that is, symmetrical about the origin where X-axis=0 and Y-axis=0). An outer diameter of the ring of the first mapping masked region 41 is smaller than a diameter of the circle of the first mapping region 40.

In some embodiments, the initial mask 3 comprises a plurality of initial unmasked regions 30, the first correction mask 4 comprises a plurality of first mapping regions 40, wherein each of the first mapping regions 40 of first correction mask 4 is where a corresponding one of the initial unmasked regions 30 of the initial mask 3 mapping to the first correction mask 4 along the propagation path of the laser beam 13. A shape and an area of each of the first mapping regions 40 are the same as a shape and an area of the corresponding one of the initial unmasked regions 30, respectively. The shape of any one of the initial unmasked regions 30 (the corresponding one of the first mapping regions 40) may be a circle, a rectangle or other shape. The shapes and the areas of the initial unmasked regions 30 (the corresponding first mapping regions 40) may be the same, partially the same or all different. The initial unmasked regions 30 (the corresponding first mapping regions 40) may be arranged in columns, rows, rows and columns, scattered arrangement, or a combination of the above arrangements.

Please refer to FIG. 3F, which is a cross-sectional schematic view of another embodiment of the laser machining mask assembly of the present invention. In current embodiment, the laser machining mask assembly 2 comprises an initial mask 3, a first correction mask 4 and a second correction mask 5, wherein the first correction mask 4 is arranged between the initial mask 3 and the second correction mask 5, and the second correction mask 5 is arranged between the first correction mask 4 and the projection lens 11. The initial mask 3 is amplitude mask type. The initial mask 3 comprises an initial masked region and one or more initial unmasked region. The first correction mask 4 comprises one or more first mapping region, wherein the one or more first mapping region of the first correction mask 4 is where the one or more initial unmasked region of the initial mask 3 mapping to the first correction mask 4 along the propagation path of the laser beam 13. Each of the one or more first mapping region and a corresponding one of the one or more initial unmasked region have an identical shape and an identical area, respectively. Any of the one or more first mapping region of the first correction mask 4 is amplitude mask type or phase mask type. The second correction mask 5 is amplitude mask type or phase mask type. A beam size of the laser beam 13 projected on a projection focal plane after the laser beam 13 propagating through the laser machining mask assembly 2 (including the initial mask 3, the first correction mask 4 and the second correction mask 5) and the projection lens 11 can indeed be effectively controlled and the diffraction pattern of the laser beam 13 projected on the projection focal plane can indeed be effectively reduced by using the first correction mask 4 and the second correction mask 5.

In some embodiments, the second correction mask 5 comprises one or more second mapping region, wherein the one or more second mapping region of the second correction mask 5 is where the one or more initial unmasked region of the initial mask 3 mapping to the second correction mask 5 along the propagation path of the laser beam 13. Each of the one or more second mapping region and a corresponding one of the one or more initial unmasked region have an identical shape and an identical area, respectively. Any of the one or more second mapping region of the second correction mask 5 is amplitude mask type or phase mask type.

In some embodiments, any of the one or more second mapping region of the second correction mask 5 is amplitude mask type, wherein each of the one or more second mapping region comprises a second mapping masked region and a second mapping unmasked region.

In some embodiments, the first correction mask 4 is arranged between the initial mask 3 and the second correction mask 5, and the initial mask 3 is arranged between the first correction mask 4 and the projection lens 11. In some other embodiments, the initial mask 3 is arranged between the first correction mask 4 and the second correction mask 5, and the second correction mask 5 is arranged between the initial mask 3 and the projection lens 11. In some other embodiments, the initial mask 3 is arranged between the first correction mask 4 and the second correction mask 5, and the first correction mask 4 is arranged between the initial mask 3 and the projection lens 11. In some other embodiments, the second correction mask 5 is arranged between the initial mask 3 and the first correction mask 4, and the first correction mask 4 is arranged between the second correction mask 5 and the projection lens 11. In some other embodiments, the second correction mask 5 is arranged between the initial mask 3 and the first correction mask 4, and the initial mask 3 is arranged between the second correction mask 5 and the projection lens 11.

In some embodiments, the initial mask 3 is amplitude mask type, the first correction mask 4 is amplitude mask type, the second correction mask 5 is amplitude mask type. In some other embodiments, the initial mask 3 is amplitude mask type, the first correction mask 4 is phase mask type, the second correction mask 5 is amplitude mask type. In some other embodiments, the initial mask 3 is amplitude mask type, the first correction mask 4 is amplitude mask type, the second correction mask 5 is phase mask type. In some other embodiments, the initial mask 3 is amplitude mask type, the first correction mask 4 is phase mask type, the second correction mask 5 is phase mask type.

In some embodiments, the laser machining mask assembly 2 comprises a plurality of initial masks 3 and a first correction mask 4, wherein the arrangement of the plurality of initial masks 3 and the first correction mask 4 can be adjusted according to the design of the plurality of initial masks 3 and the first correction mask 4. In some other embodiments, the laser machining mask assembly 2 comprises a plurality of initial masks 3 and a plurality of first correction masks 4, wherein the arrangement of the plurality of initial masks 3 and the plurality of first correction masks 4 can be adjusted according to the design of the plurality of initial masks 3 and the plurality of first correction masks 4. In some other embodiments, the laser machining mask assembly 2 comprises an initial mask 3 and a plurality of first correction masks 4, wherein the arrangement of the initial mask 3 and the plurality of first correction masks 4 can be adjusted according to the design of the initial mask 3 and the plurality of first correction masks 4.

In addition, the present invention further provides a projection laser machining method using a laser machining mask assembly, which comprises following steps of: providing a machining laser apparatus 10, the laser machining mask assembly 2 and a projection lens 11 such that the laser machining mask assembly 2, the projection lens 11 and a workpiece 12 are sequentially arranged on a propagation path of a laser beam 13 generated by the machining laser apparatus 10 along a propagation direction of the laser beam 13, wherein the laser machining mask assembly 2 comprises an initial mask 3 and a first correction mask 4, the initial mask 3 is amplitude mask type, the first correction mask 4 is amplitude mask type or phase mask type, the first correction mask 4 is arranged between the initial mask 3 and the projection lens 11 or the initial mask 3 is arranged between the first correction mask 4 and the projection lens 11; and performing a laser machining process on the workpiece 12; wherein a beam size of the laser beam 13 projected on a projection focal plane after the laser beam 13 propagating through the laser machining mask assembly 2 (including the initial mask 3 and the first correction mask 4) and the projection lens 11 can be effectively controlled and the diffraction pattern of the laser beam 13 projected on the projection focal plane can be effectively reduced by using the first correction mask 4. The laser machining process is a laser drilling process, a laser scribing process, a laser polishing process, a laser patterning process or any combination thereof. The laser drilling process in the specification of the present invention may refer to the process of laser drilling a hole on the workpiece 12 with a depth less than a thickness of the workpiece 12, or may refer to the process of laser drilling a through hole on the workpiece 12, wherein the through hole penetrates the workpiece 12. The laser scribing process in the specification of the present invention may refer to the process of laser scribing a groove on the workpiece 12 with a depth less than the thickness of the workpiece 12, or may refer to the process of laser scribing a groove on the workpiece 12, wherein the groove penetrates the workpiece 12.

In some embodiments, the laser machining mask assembly 2 of the projection laser machining method of the present invention further comprises a second correction mask 5, wherein the initial mask 3 is arranged between the first correction mask 4 and the second correction mask 5 or the first correction mask 4 is arranged between the initial mask 3 and the second correction mask 5. The second correction mask 5 is amplitude mask type or phase mask type. A beam size of the laser beam 13 projected on a projection focal plane after the laser beam 13 propagating through the laser machining mask assembly 2 (including the initial mask 3, the first correction mask 4 and the second correction mask 5) and the projection lens 11 can be effectively controlled and the diffraction pattern of the laser beam 13 projected on the projection focal plane can be effectively reduced by using the first correction mask 4 and the second correction mask 5.

In some embodiments, the laser machining mask assembly 2 of the projection laser machining method of the present invention can be any of the aforementioned laser machining mask assembly 2.

In some embodiments, the machining laser apparatus 10 of the projection laser machining system 1 may be an excimer laser, a solid state laser or a fiber laser, wherein a wavelength of the excimer laser may be 248 nm or 193 nm, wherein a wavelength of the solid state laser may be 1064 nm, 532 nm, 355 nm or 263 nm, wherein a wavelength of the fiber laser may be 1030 nm, 515 nm, 343 nm or 258 nm.

As disclosed in the above description and attached drawings, the present invention can provide a projection laser machining method using a laser machining mask assembly. It is new and can be put into industrial use.

Although the embodiments of the present invention have been described in detail, many modifications and variations may be made by those skilled in the art from the teachings disclosed hereinabove. Therefore, it should be understood that any modification and variation equivalent to the spirit of the present invention be regarded to fall into the scope defined by the appended claims.

What is claimed is:

1. A projection laser machining method using a laser machining mask assembly, comprising following steps of:
providing a machining laser apparatus, the laser machining mask assembly and a projection lens such that the laser machining mask assembly, the projection lens and a workpiece are sequentially arranged on a propagation path of a laser beam generated by the machining laser apparatus along a propagation direction of the laser beam, wherein the laser machining mask assembly comprises an initial mask and a first correction mask, the initial mask is amplitude mask type, the first correction mask is amplitude mask type or phase mask type, the first correction mask is arranged between the initial mask and the projection lens or the initial mask is arranged between the first correction mask and the projection lens; and
performing a laser machining process on the workpiece;
wherein a beam size of the laser beam projected on a projection focal plane after the laser beam propagating through the laser machining mask assembly and the projection lens can be effectively controlled by using the first correction mask.

2. The projection laser machining method using the laser machining mask assembly according to claim 1, wherein the initial mask comprises:
an initial masked region; and
one or more initial unmasked region;
wherein the first correction mask comprises:
one or more first mapping region, wherein the one or more first mapping region of the first correction mask is where the one or more initial unmasked region of the initial mask mapping to the first correction mask along the propagation path of the laser beam, each of the one or more first mapping region and a corresponding one of the one or more initial unmasked region have an identical shape and an identical area respectively, any of the one or more first mapping region is amplitude mask type or phase mask type.

3. The projection laser machining method using the laser machining mask assembly according to claim 2, wherein at least one of the one or more first mapping region is amplitude mask type, the at least one of the one or more first mapping region comprises:
a first mapping masked region; and
a first mapping unmasked region.

4. The projection laser machining method using the laser machining mask assembly according to claim 3, wherein the at least one of the one or more first mapping region has a shape of a circle.

5. The projection laser machining method using the laser machining mask assembly according to claim 3, wherein the first correction mask is arranged between the initial mask and the projection lens, the at least one of the one or more first mapping region has a shape of a circle, the first mapping masked region of the at least one of the one or more first mapping region has a shape of a ring, wherein the ring is symmetrical about a center of the circle.

6. The projection laser machining method using the laser machining mask assembly according to claim 5, wherein an outer diameter of the ring is smaller than a diameter of the circle.

7. The projection laser machining method using the laser machining mask assembly according to claim 6, wherein a ratio of an inner diameter of the ring to the diameter of the circle is between 2:15 and 2:5; a ratio of the outer diameter of the ring to the diameter of the circle is between 2:3 and 14:15.

8. The projection laser machining method using the laser machining mask assembly according to claim 5, wherein the diameter of the circle is greater than or equal to 10 times a wavelength of the laser beam and smaller than or equal to 91 times the wavelength of the laser beam.

9. The projection laser machining method using the laser machining mask assembly according to claim 8, wherein a spacing is between the initial masked region and the first mapping masked region along the propagation direction of the laser beam, the spacing is greater than or equal to 403 times the wavelength of the laser beam and smaller than or equal to 24194 times the wavelength of the laser beam.

10. The projection laser machining method using the laser machining mask assembly according to claim 3, wherein the initial mask comprises:
an initial mask substrate; and
an initial masking layer, wherein the initial masking layer is formed on a first surface of the initial mask substrate within the initial masked region of the initial mask.

11. The projection laser machining method using the laser machining mask assembly according to claim 10, wherein the initial mask substrate has a second surface, the second surface is relative to the first surface of the initial mask substrate along the propagation path of the laser beam, the first correction mask comprises:
a first correction masking layer formed on the second surface of the initial mask substrate, the first correction masking layer is the first mapping masked region of the at least one of the one or more first mapping region of the first correction mask.

12. The projection laser machining method using the laser machining mask assembly according to claim 10, wherein the initial mask substrate of the initial mask comprises one or more penetrating through region, the one or more penetrating through region penetrates through the initial mask substrate along the propagation direction of the laser beam, the one or more penetrating through region is the one or more initial unmasked region of the initial mask.

13. The projection laser machining method using the laser machining mask assembly according to claim 10, wherein the first correction mask comprises:
a first correction mask substrate; and
a first correction masking layer formed on a surface of the first correction mask substrate within the first mapping masked region of the at least one of the one or more first mapping region of the first correction mask.

14. The projection laser machining method using the laser machining mask assembly according to claim 3, wherein the initial mask comprises an initial mask base, the initial mask base comprises one or more penetrating through region and a non-penetrating region, the one or more penetrating through region penetrates through the initial mask base along the propagation direction of the laser beam, the one or more penetrating through region is the one or more initial unmasked region of the initial mask, the non-penetrating region is the initial masked region of the initial mask.

15. The projection laser machining method using the laser machining mask assembly according to claim 14, wherein the first correction mask comprises:
a first correction mask substrate; and
a first correction masking layer formed on a surface of the first correction mask substrate within the first mapping masked region of the at least one of the one or more first mapping region of the first correction mask.

16. The projection laser machining method using the laser machining mask assembly according to claim 2, wherein the first correction mask further comprises one or more surrounding region, each of the one or more surrounding region surrounds a corresponding one of the one or more first mapping region.

17. The projection laser machining method using the laser machining mask assembly according to claim 16, wherein any one of the one or more surrounding region and a corresponding one of the one or more first mapping region are both amplitude mask type or both phase mask type.

18. The projection laser machining method using the laser machining mask assembly according to claim 16, wherein at least one of the one or more surrounding region and a corresponding one of the one or more first mapping region are both amplitude mask type, each of the at least one of the one or more surrounding region comprises:
a surrounding masked region; and
a surrounding unmasked region;
wherein the corresponding one of the one or more first mapping region comprises:
a first mapping masked region; and
a first mapping unmasked region.

19. The projection laser machining method using the laser machining mask assembly according to claim 18, wherein the at least one of the one or more first mapping region has a shape of a mapping rectangle.

20. The projection laser machining method using the laser machining mask assembly according to claim 18, wherein the surrounding masked region of the at least one of the one or more surrounding region is connected to the first mapping masked region of the corresponding one of the one or more first mapping region.

21. The projection laser machining method using the laser machining mask assembly according to claim 18, wherein the first correction mask is arranged between the initial mask and the projection lens, the surrounding masked region of the at least one of the one or more surrounding region is connected to the first mapping masked region of the corresponding one of the one or more first mapping region to form a connected rectangle.

22. The projection laser machining method using the laser machining mask assembly according to claim 18, wherein the first correction mask is arranged between the initial mask and the projection lens, one of the one or more first mapping region and a corresponding one of the one or more surrounding region are both amplitude mask type, the one of the one or more first mapping region has a shape of a mapping rectangle, the first mapping masked region of the one of the one or more first mapping region is connected to the surrounding masked region of the corresponding one of the one or more surrounding region to form a connected rectangle, a geometric center of the mapping rectangle is coincident with a geometric center of the connected rectangle, a longer side of the mapping rectangle is parallel with a longer side of the connected rectangle.

23. The projection laser machining method using the laser machining mask assembly according to claim 22, wherein the longer side of the mapping rectangle is smaller than the longer side of the connected rectangle, a shorter side of the mapping rectangle is greater than a shorter side of the connected rectangle.

24. The projection laser machining method using the laser machining mask assembly according to claim 23, wherein a ratio of the longer side of the mapping rectangle to the longer side of the connected rectangle is between 5:12 and 15:44; a ratio of the shorter side of the mapping rectangle to the shorter side of the connected rectangle is between 2:1 and 6:5.

25. The projection laser machining method using the laser machining mask assembly according to claim 22, wherein the longer side of the mapping rectangle is greater than or equal to 10 times a wavelength of the laser beam and smaller than or equal to 91 times the wavelength of the laser beam, a shorter side of the mapping rectangle is greater than or equal to 8 times the wavelength of the laser beam and smaller than or equal to 73 times the wavelength of the laser beam.

26. The projection laser machining method using the laser machining mask assembly according to claim 25, wherein a spacing is between the initial masked region and the first mapping masked region along the propagation direction of the laser beam, the spacing is greater than or equal to 403 times the wavelength of the laser beam and smaller than or equal to 24194 times the wavelength of the laser beam.

27. The projection laser machining method using the laser machining mask assembly according to claim 2, wherein the laser machining mask assembly further comprises a second correction mask, the initial mask is arranged between the first correction mask and the second correction mask or the first correction mask is arranged between the initial mask and the second correction mask, the second correction mask is amplitude mask type or phase mask type, wherein the beam size of the laser beam projected on the projection focal plane after the laser beam propagating through the laser machining mask assembly and the projection lens can be effectively controlled by using the first correction mask and the second correction mask.

28. The projection laser machining method using the laser machining mask assembly according to claim 27, wherein the second correction mask comprises:
one or more second mapping region, wherein the one or more second mapping region of the second correction mask is where the one or more initial unmasked region of the initial mask mapping to the second correction mask along the propagation path of the laser beam, each of the one or more second mapping region and a corresponding one of the one or more initial unmasked region have an identical shape and an identical area respectively, any of the one or more second mapping region is amplitude mask type or phase mask type.

29. The projection laser machining method using the laser machining mask assembly according to claim 28, wherein at least one of the one or more second mapping region is amplitude mask type, the at least one of the one or more second mapping region comprises:
a second mapping masked region; and
a second mapping unmasked region.

30. The projection laser machining method using the laser machining mask assembly according to claim 1, wherein the laser machining process is a laser drilling process, a laser scribing process, a laser polishing process, a laser patterning process or any combination thereof.
